(19) United States
(12) Patent Application Publication
(10) Pub. No.: US 2022/0414767 A1
(43) Pub. Date: Dec. 29, 2022

(54) SYSTEMS AND METHODS FOR REAL-TIME PROCESSING OF RESOURCE REQUESTS

(71) Applicant: The Toronto-Dominion Bank, Toronto (CA)

(72) Inventors: Alexandra TSOURKIS, Toronto (CA); Blair Buxton, Toronto (CA); Buturab Rizvi, Toronto (CA); Umer M. Adil, Toronto (CA)

(73) Assignee: The Toronto-Dominion Bank, Toronto (CA)

(21) Appl. No.: 17/901,683

(22) Filed: Sep. 1, 2022

Related U.S. Application Data
(63) Continuation of application No. 16/448,181, filed on Jun. 21, 2019.

(51) Int. Cl. G06Q 40/02; G06Q 30/02

(52) U.S. Cl. CPC G06Q 40/025; G06Q 30/0278

(57) ABSTRACT

A processor-implemented method is disclosed. The method includes: receiving user input including a selection of a vehicle and personal data for an entity; obtaining value data for the selected vehicle; accessing database records associated with accounts of the entity at a resource server to obtain pre-qualification information for the entity; determining based on the pre-qualification information for the entity, that the entity is qualified for borrowing resources in connection with the selected vehicle; and in response to determining that the entity is qualified, selectively provide access to the user-inputted personal data for the entity.

### CROSS-REFERENCE TO RELATED APPLICATION

The present application is a continuation of U.S. patent application Ser. No. 16/448,181 filed on Jun. 21, 2019, the contents of which are incorporated herein by reference.

### TECHNICAL FIELD

The present disclosure relates to data processing systems and, in particular, to systems and methods for processing, in real-time, resource requests to a resource server.

### BACKGROUND

Since retailers, such as automobile dealers, are typically situated remotely from resource lenders, computer systems may be employed to allow retailers to submit resource requests on behalf of purchasers. For example, a computing system associated with a retailer may receive various data about a prospective purchaser and a resource request may be sent from the retailer computing system to a resource lender. Such processing may, in some instances, lead to unnecessary consumption of computing resources. A customer may, for example, attend multiple different retailers before making a purchase, and so the same data may be input multiple times in generating resource requests. Further, data for populating resource requests may be input, only for the purchaser and/or the dealers to ultimately find out that the requests are denied by the resource lender.

### BRIEF DESCRIPTION OF DRAWINGS

Reference will now be made, by way of example, to the accompanying drawings which show example embodiments of the present application and in which:

FIG. 1 is a schematic operation diagram illustrating an operating environment of an example embodiment;

FIG. 2 is a high-level schematic diagram of an example computing device;

FIG. 3 shows a simplified organization of software components stored in memory of the example computing device of FIG. 2;

FIG. 4 shows, in flowchart form, an example method for processing resource requests originating from client devices associated with purchaser entities;

FIG. 5 shows, in flowchart form, another example method for processing resource requests originating from client devices associated with purchaser entities;

FIG. 6 shows, in flowchart form, an example method for providing vehicle data to client devices associated with purchaser entities;

FIG. 7 shows, in flowchart form, an example method for matching purchaser entities with dealers; and

FIG. 8 shows an example sequence diagram illustrating interactions between client devices, dealer computing systems, resource server, and resource usage tracking server.

Like reference numerals are used in the drawings to denote like elements and features.

### DETAILED DESCRIPTION OF EXAMPLE EMBODIMENTS

In an aspect, the present disclosure describes a computing system. The computing system includes a processor and a memory coupled to the processor. The memory stores processor-executable instructions that, when executed by the processor, configure the processor to: receive, via a graphical user interface on a client device over a computer network, user input including a selection of a vehicle and personal data for an entity; obtain, via requests to an application programming interface (API) associated with a database storing vehicle data, value data for the selected vehicle; access database records associated with accounts of the entity at a resource server to obtain pre-qualification information for the entity, the accessing including obtaining account data associated with the accounts for determining resource borrowing capacity of the entity; determine, based on the pre-qualification information for the entity, that the entity is qualified for borrowing resources in connection with the selected vehicle; and in response to determining that the entity is qualified, selectively provide access to the user-inputted personal data for the entity, the selectively providing including: providing, via the graphical user interface, display data associated with dealer information of dealers for the selected vehicle based on tracked location information; receiving, via the graphical user interface, selection of dealers; generating a unique pre-populated resource request for borrowing resources in connection with the selected vehicle; and transmitting, to a plurality of computing systems associated with the selected dealers over the computer network, the unique pre-populated resource request including the user-inputted personal data.

In some implementations, the pre-qualification information for the entity may be obtained based on the user-inputted personal data for the entity, the value data for the selected vehicle, and the account data associated with the accounts.

In some implementations, the pre-qualification information may include at least one of available resource borrowing information for the entity or an indication of whether the entity is pre-approved for resource borrowing.

In some implementations, the instructions, when executed, may further configure the processor to: obtain a unique identifier for the entity; and transmit, to the client device, the unique identifier for the entity for displaying via the graphical user interface on the client device.

In some implementations, obtaining pre-qualification information for the entity may include performing a soft check for the entity based on historical resource usage data for the entity.

In some implementations, performing the soft check for the entity may include: sending, to a resource usage tracking server, a soft inquiry including identifying information for the entity; and receiving, from the resource usage tracking server, the historical resource usage data for the entity.

In some implementations, the instructions, when executed, may further configure the processor to: receive, from a computing system associated with one of the selected dealers over the computer network, a completed resource request, the completed resource request based on the pre-populated resource request; and in response to receiving the completed resource request, perform a hard check for the entity based on the historical resource usage data for the entity.

In some implementations, the instructions, when executed, may further configure the processor to: receive, from the client device, input of vehicle selection criteria; and provide, via the graphical user interface on the client device, vehicle data for a plurality of vehicles based on the vehicle selection criteria.

In some implementations, the instructions, when executed, may further configure the processor to: filter the vehicle data based on the pre-qualification information; and provide, via the graphical user interface on the client device, the filtered vehicle data.

In some implementations, the user input may further include a user-inputted trade-in value, and wherein the pre-qualification information for the entity is determined based on the inputted trade-in value.

In another aspect, the present disclosure describes a processor-implemented method. The method includes: receiving, by a computing system via a graphical user interface on a client device over a computer network, user input including a selection of a vehicle and personal data for an entity; obtaining, by the computing system via requests to an application programming interface (API) associated with a database storing vehicle data, value data for the selected vehicle; accessing, by the computing system, database records associated with accounts of the entity at a resource server to obtain pre-qualification information for the entity, the accessing including obtaining account data associated with the accounts for determining resource borrowing capacity of the entity; determining, by the computing system, based on the pre-qualification information for the entity, that the entity is qualified for borrowing resources in connection with the selected vehicle; and in response to determining that the entity is qualified, selectively provide access to the user-inputted personal data for the entity, the selectively providing including: providing, by the computing system via the graphical user interface, display data associated with dealer information of dealers for the selected vehicle based on tracked location information; receiving, by the computing system via the graphical user interface, selection of dealers; generating, by the computing system, a unique pre-populated resource request for borrowing resources in connection with the selected vehicle; and transmitting, by a computing system to a plurality of computing systems associated with the selected dealers over the computer network, the unique pre-populated resource request including the user-inputted personal data.

In another aspect, the present disclosure describes a computer-readable storage medium. The storage medium stores instructions that, when executed by a processor, cause the processor to perform operations including: receiving, via a graphical user interface on a client device over a computer network, user input including a selection of a vehicle and personal data for an entity; obtaining, via requests to an application programming interface (API) associated with a database storing vehicle data, value data for the selected vehicle; accessing, database records associated with accounts of the entity at a resource server to obtain pre-qualification information for the entity, the accessing including obtaining account data associated with the accounts for determining resource borrowing capacity of the entity; determining, based on the pre-qualification information for the entity, that the entity is qualified for borrowing resources in connection with the selected vehicle; and in response to determining that the entity is qualified, selectively provide access to the user-inputted personal data for the entity, the selectively providing including: providing, via the graphical user interface, display data associated with dealer information of dealers for the selected vehicle based on tracked location information; receiving, via the graphical user interface, selection of dealers; generating, a unique pre-populated resource request for borrowing resources in connection with the selected vehicle; and transmitting, to a plurality of computing systems associated with the selected dealers over the computer network, the unique pre-populated resource request including the user-inputted personal data.

In an aspect, the present disclosure describes a computing device. The computing device includes a processor, a communications module coupled to the processor, and a memory coupled to the processor. The memory stores instructions that, when executed, configure the processor to: receive, via the communications module from a client device associated with an entity, input including a selection of a vehicle and personal data for the entity; obtain value data for the selected vehicle; obtain pre-qualification information for the entity based on the personal data for the entity and the value data for the selected vehicle; determine, based on the pre-qualification information for the entity, that the entity is qualified; and in response to determining that the entity is qualified, send, to a computing system associated with a dealer for the selected vehicle, a pre-populated resource request, the pre-populated resource request including at least a portion of the personal data.

In some implementations, the instructions may further configure the processor to obtain account data associated with the entity from a database record that is accessible by the computing device, wherein the pre-qualification information for the entity is obtained based on the personal data for the entity, the value data for the selected vehicle, and the account data associated with the entity.

In some implementations, the pre-qualification information may comprise at least one of available resource borrowing information for the entity or an indication of whether the entity is pre-approved for resource borrowing.

In some implementations, the instructions may further configure the processor to: obtain a unique identifier for the entity; and transmit, to the client device, the unique identifier for the entity for displaying on the client device.

In some implementations, obtaining pre-qualification information for the entity may comprise performing a soft check for the entity based on historical resource usage data for the entity.

In some implementations, performing the soft check for the entity may comprise: sending, to a resource usage tracking server, a soft inquiry, the soft inquiry including identifying information for the entity; and receiving, from the resource usage tracking server, the historical resource usage data for the entity.

In some implementations, the instructions may further configure the processor to: receive, from the computing system associated with the dealer for the selected vehicle, a completed resource request, the completed resource request based on the pre-populated resource request; and in response to receiving the completed resource request, perform a hard check for the entity based on the historical resource usage data for the entity.

In some implementations, the instructions may further configure the processor to: receive, from the client device, input of vehicle selection criteria; and provide, to the client device, vehicle data for a plurality of vehicles based on the vehicle selection criteria.

In some implementations, the instructions may further configure the processor to: filter the vehicle data based on the pre-qualification information; and provide, to the client device, the filtered vehicle data.

In some implementations, the input may further include an entity-inputted trade-in value, and wherein the pre-qualification information for the entity is determined based on the inputted trade-in value.

In another aspect, the present disclosure describes a method for real-time processing of purchaser qualification data. The method includes: receiving, from a client device associated with an entity, input including a selection of a vehicle and personal data for the entity; obtaining value data for the selected vehicle; obtaining pre-qualification information for the entity based on the personal data for the entity and the value data for the selected vehicle; determining, based on the pre-qualification information for the entity, that the entity is qualified; and in response to determining that the entity is qualified, sending, to a computing system associated with a dealer for the selected vehicle, a pre-populated resource request, the pre-populated resource request including at least a portion of the personal data.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In an aspect, the present application provides systems and methods for processing resource requests directed to a resource server. More specifically, methods are disclosed for managing requests to a resource server for resources to support tasks that are requested to be performed at one or more nodes connected to a client device. In particular, the resource requests may be financing applications to support purchase activities of a purchaser entity associated with a client device. For example, the resource requests may be applications for vehicle financing that are routed to one or more computing systems associated with vehicle dealerships. The resource requests are generated based on personal data and vehicle selections and/or preferences transmitted from the client devices. Software, such as a mobile application or browser extension, that is resident on a client device may be configured to retrieve vehicle data from databases storing data for a plurality of vehicles, and presents the vehicle data to a user of the client device. User input, including personal data and vehicle selections and/or preferences, is received via the client device and processed to obtain pre-qualification information for the user. A vehicle that the purchaser entity can afford is then identified based on the pre-qualification information, and a pre-populated resource request is sent to a computing system associated with a dealer for the selected vehicle. For example, a pre-populated financing application for the selected vehicle containing, at least, vehicle and purchaser information is routed to a computing system associated with a dealer that has the selected vehicle available in its inventory.

In another aspect, the present application provides a platform which allows prospective purchasers of vehicles to connect with a network of dealers and to exchange up-to-date data informing purchase decisions. Specifically, a system is disclosed for facilitating dynamic updating of rates and dealer data for user-selected vehicles. The system is configured to retrieve, in real-time, rates and dealer data for one or more different dealers and provide the data to client devices. The data provided to client devices is updated dynamically based on user input of personal data, vehicle selections and/or preference criteria, value data for the selected vehicle(s), and/or quantity of resources associated with accounts of the prospective purchaser at a resource server. In particular, the rates and dealer data may be filtered based on pre-qualification information for a prospective purchaser, and the filtered data may be provided to a client device associated with the prospective purchaser.

In yet another aspect, the present application discloses a resource server for receiving and processing resource requests. The resource requests may be requests for resources to support activities or tasks performed at specific nodes connected to a client device. In particular, the resource server may function as an intermediary between computing systems associated with dealers and client devices associated with prospective purchasers of vehicles. When a customer has identified a vehicle that they can afford, the resource server may provide the customer's information to one or more selected dealers. In particular, the resource server may provide, among others, customer identification information, vehicle selections and/or preference data, and pre-qualification information for the customer to dealer computer node(s). The pre-qualification information may be obtained based, at least in part, on quantity of resources associated with the customer at the resource server. That is, the pre-qualification information is based on data that is stored at or is locally accessible by the resource server.

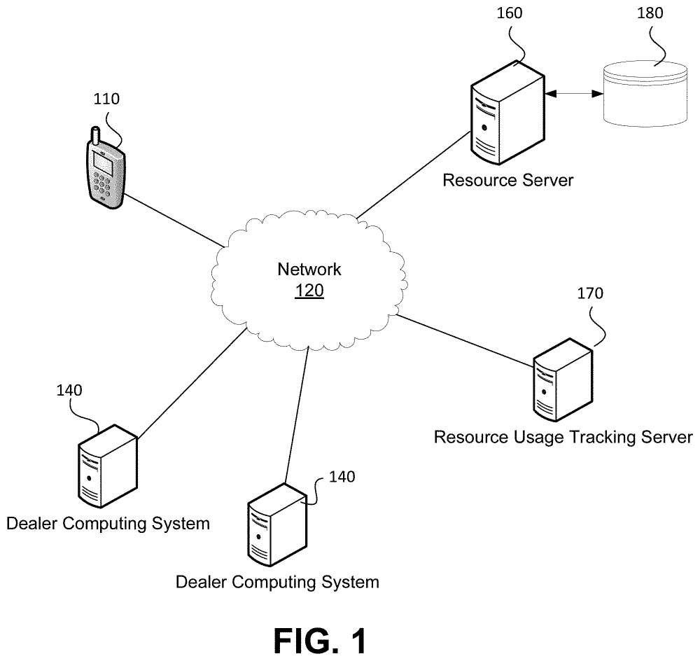

FIG. 1 is a schematic diagram illustrating an operating environment of an example embodiment. In particular, FIG. 1 illustrates exemplary components of a system for processing resource requests to a resource server. As a specific example, the system of FIG. 1 may be implemented to facilitate vehicle purchases by various entities. Requests for resources supporting purchase actions by the entities may originate from client devices associated with those entities. The resource requests may be routed to various components of the system via a network 120.

As illustrated, a resource server 160 (which may also be referred to as a server computer system) and client device 110 communicate via the network 120. The client device 110 is a computing device that may be associated with an entity, such as a user or client, having resources associated with the resource server 160. For example, the resource server 160 may track, manage, maintain, and/or lend resources to the entity. The resources may, for example, be computing resources, such as memory or processor cycles. By way of further example, the resources may include stored value, such as fiat currency, which may be represented in a database. For example, the resource server 160 may be coupled to a database 180, which may be provided in secure storage. The secure storage may be provided internally within the resource server 160 or externally. The secure storage may, for example, be provided remotely from the resource server 160. For example, the secure storage may include one or more data centers. The data centers may, for example, store data with bank-grade security.

The database 180 may include records for a plurality of accounts and at least some of the records may define a quantity of resources associated with an entity. For example, the entity that is associated with the client device 110 may be associated with an account having one or more records in the database. The records may reflect a quantity of stored resources that are associated with the entity. Such resources may include owned resources and, in at least some embodiments, borrowed resources (e.g. resources available on credit). The quantity of resources that are available to or associated with an entity may be reflected by a balance defined in an associated record such as, for example, a bank balance.

The resource server 160 may, for example, be a financial institution server and the entity may be a customer of a financial institution operating the financial institution server.

The client device 110 may be used, for example, to configure a data transfer from an account associated with the client device 110. More particularly, the client device 110 may be used to configure a data transfer from an account associated with an entity operating the client device 110. The data transfer may involve a transfer of data between a record in the database 180 associated with such an account and another record in the database 180 (or in another database such as a database associated with another server (not shown) which may be provided by another financial institution, for example, and which may be coupled to the resource server 160 via a network). The other record is associated with a data transfer recipient such as, for example, a bill payment recipient. The data involved in the transfer may, for example, be units of value and the records involved in the data transfer may be adjusted in related or corresponding manners. For example, during a data transfer, a record associated with the data transfer recipient may be adjusted to reflect an increase in value due to the transfer whereas the record associated with the entity initiating the data transfer may be adjusted to reflect a decrease in value which is at least as large as the increase in value applied to the record associated with the data transfer recipient.

The client device 110 may be used to facilitate vehicle purchase actions of a purchaser entity associated with the client device 110. For example, the client device 110 may be configured to retrieve vehicle data for a plurality of vehicles and present the data to users of the client device 110. The client device 110 may also be configured to receive input of various information, such as vehicle trade-in estimates, personal data (e.g. identifying information, financial information), and vehicle selections and/or preferences of the purchaser entity, which form the basis of pre-qualification information for obtaining, by the purchaser entity, financing for a desired vehicle. In some embodiments, the client device 110 may allow the purchaser entity to initiate a resource request, such as a financing application, that is directed to a resource server. For example, a purchasing entity using the client device 110 may be prompted to initialize a financing application during a vehicle selection process, which financing application is routed to a selected dealer and ultimately to a resource server.

The resource server 160 may be in communication with a resource usage tracking server 170 via the network 120. The resource usage tracking server 170 may maintain a history of borrowing of resources by various entities including, for example, the entity associated with the client device 110 and associated with an account having one or more records in the database 180.

For example, the resource usage tracking server 170 may maintain historical resource usage data associated with the various entities. Such data may be maintained on a per-entity basis, with each entity having its own associated historical resource usage data. The historical resource usage data may identify, for example, third parties that have a credit relationship with the entity associated with a particular instance of the historical resource usage data, such as a particular record of the historical resource usage data. The historical resource usage data may, for example, be a credit report. A credit report is a record of a borrower's credit history from a number of sources including, for example, credit card companies, banks, collection agencies and/or governments. A credit score, which is a numerical representation of a borrower's creditworthiness, may be obtained based on a credit report. The historical resource usage data, such as the credit report, may identify various resource event data including, any one or a combination of: a borrowed resource history (such as a credit history), a resource transfer history (such as a record of payments including, for example, an indication of whether such payments were on time or late), failed transfer information (such as information regarding cheques that were returned for having non-sufficient funds and/or information about accounts that were sent to a collection agency, bureau or process due to non-transfer of resources), resource shortage information (such as data regarding prior bankruptcies or other data indicating that an entity had insufficient resources to satisfy data transfer requirements), borrowed resource information (such as information about loans including secured and unsecured loans), and/or data of another type.

In some embodiments, the resource event data may include a third party identifier. The third party identifier may, for example, be a name of a third party that is associated with such data. For example, the name of a third party that added or caused to be added an entry to the historical resource usage data may be identified. By way of example, the resource transfer history may identify a plurality of third parties who have a past history of requesting and/or receiving transfers from the entity. By way of further example, the failed transfer information may identify a third party that was to be the recipient of the failed transfer. By way of further example, the borrowed resource information may identify a third party that previously lent resources to the entity.

In some embodiments, the resource event data may include identification information that a defined third party associates with the entity. For example, an account number, a partial account number, or other customer identifier may be included in the historical resource usage data. By way of example, the historical resource usage data may indicate that a given third party (e.g., “The Phone Company”) identifies the entity with a defined account number (e.g., 798126).

The historical resource usage data may include other information instead of or in addition to the information defined above. For example, the historical resource usage data may include a listing of third parties that have previously retrieved and/or requested historical resource usage data maintained by the resource usage tracking server 170 (e.g., a listing of third parties that previously requested a credit report). By way of further example, the historical resource usage data may include identification and/or biographical information for the entity. Such information may include, for example, any one or more of: a name, address, date of birth, marital status, current and/or past employment information (e.g., a title, a date of employment, income amount, name of employer, etc.), contact information (such as a telephone number, etc.), a government issued identification number (e.g., a social insurance number (SIN), a passport number and/or driver's license number), or other information.

Various entries of data, such as, for example, the resource event data, may include a date associated therewith. The date may, for example, be a reporting and/or verification date. The date may reflect freshness of the associated entry of data such that entries with a more recent date may be considered to be fresher than entries with an older date.

The resource usage tracking server 170 may include an application programming interface (API) which allows the resource server 160 to request for and receive historical resource usage data for an entity. By way of example, the API may allow the resource server 160 to retrieve the historical resource usage data for an entity by sending a message which includes identification information for the entity to the resource usage tracking server 170. The identification information may, for example, include any one or combination of: a name, government issued identification number, an address, a date of birth, contact information (e.g., a telephone number), or identification of another type. The resource usage tracking server 170 uses such identification information to retrieve a historical resource usage data associated with the entity. For example, an appropriate record in a database may be retrieved based on the identification information. The resource usage tracking server 170 may then send the historical resource usage data for the entity to the resource server 160.

The system of FIG. 1 also includes one or more dealer computing systems 140 associated with vehicle dealers. The dealer computing systems 140 may, for example, comprise server computers operated by vehicle dealers. The dealer computing systems 140 may implement software solutions for various functions relating to vehicle sales and deal flow management including, for example, digital retailing, management of credit applications and contract activity, and generation of dealer reports (e.g. financial summaries, market insights, etc.). In at least some embodiments, the dealer computing systems 140 may be part of or have access to a financing network comprising one or more financing sources for vehicle purchase activities. For example, the dealer computing systems 140 may be connected for communication with servers associated with major financial institutions, non-prime lenders, and/or credit unions. The dealer computing systems 140 may be configured to receive and process resource requests originating from client devices associated with various purchaser entities. In particular, dealer computing systems 140 may receive pre-populated resource requests from client devices and process such requests before forwarding them to one or more resource servers.

The client device 110, the dealer computing systems 140, the resource server 160, and the resource usage tracking server 170 may be in geographically disparate locations. Put differently, the client device 110 may be remote from at least one of the dealer computing system 140, the resource server 160, and the resource usage tracking server 170.

The client device 110, the resource server 160, and the resource usage tracking server 170 are computer systems. The client device 110 may take a variety of forms including, for example, a mobile communication device such as a smartphone, a tablet computer, a wearable computer such as a head-mounted display or smartwatch, a laptop or desktop computer, or a computing device of another type.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

In the example of FIG. 1, the resource server 160 may provide both data transfer processing (e.g., bill payment) and data holding (e.g., banking) functions. That is, the resource server 160 may be both a financial institution server and also a bill payment processing server. The resource server 160 may, in some embodiments, be a proxy server, serving as an intermediary for requests for client devices 110 seeking resources from other servers. For example, the resource server 160 may be a proxy connecting client devices 110 to servers or data stores storing vehicle data (e.g. make, model, price, etc.) for a plurality of vehicles.

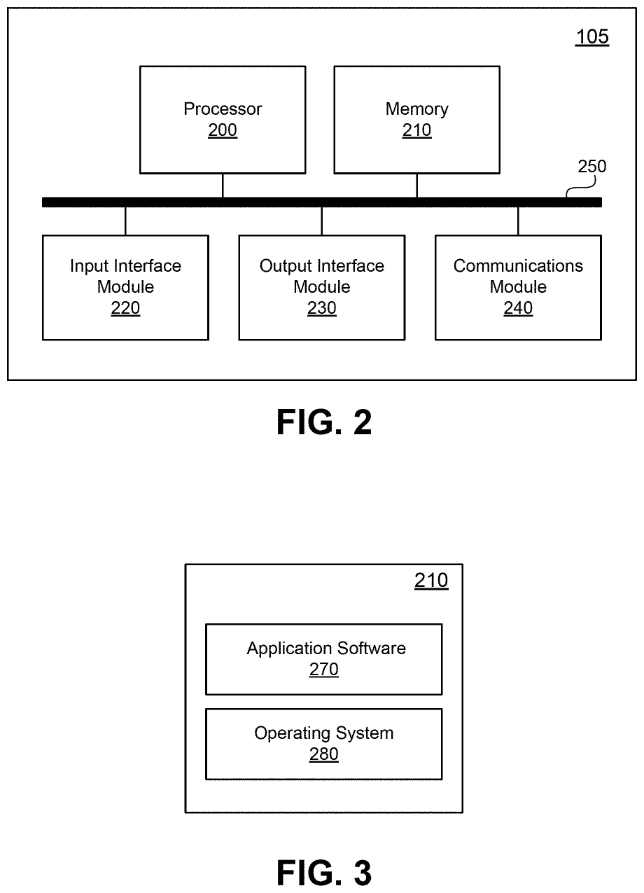

FIG. 2 is a high-level operation diagram of the example computing device 105. In some embodiments, the example computing device 105 may be exemplary of one or more of the client device 110, the dealer computing systems 140, the resource server 160, and the resource usage tracking server 170. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally or alternatively, instructions may be executed by the processor 200 directly from read-only memory of memory 210.

FIG. 3 depicts a simplified organization of software components stored in memory 210 of the example computing device 105. As illustrated these software components include an operating system 280 and application software 270.

The operating system 280 is software. The operating system 280 allows the application software 270 to access the processor 200, the memory 210, the input interface module 220, the output interface module 230 and the communications module 240. The operating system 280 may be, for example, Apple iOS™, Google™ Android™, Linux™, Microsoft™ Windows™, or the like.

The application software 270 adapts the example computing device 105, in combination with the operating system 280, to operate as a device performing a particular function. The application software 270 may, for example, comprise a resource request application for requesting resources from a resource server. In particular, the resource request application may be used for generating requests for resources from a lender entity, such as a resource server, to support purchase activities of an entity that is associated with the client device 105. For example, the resource request application may be used to request financing for personal property, such as a vehicle. The resource request application may also serve as a consumer tool for facilitating vehicle purchases. In particular, the resource request application may be used to search, select, and reserve vehicles online, and to request and obtain purchase-related data (e.g. sales price, payment rates, trade-in values, financing details, pre-qualification information, etc.). A user interface of the resource request application may present vehicle data to the purchaser entity and facilitate entry of input, such as personal data, vehicle selection and/or preferences, etc. The resource request application may be a stand-alone application, such as a mobile app, or integrated into another application or software module resident on the example computing device 105 as a sub-function or feature.

The resource request application is associated with a backend application server. In at least some embodiments, a resource server, from which resources are requested by a client device 110, may also serve as the backend application server for the resource request application. In particular, various functions of the resource request application may be provided, at least in part, by a resource server. For example, a server associated with a financial institution may perform backend services of the resource request application. Accordingly, the resource server may be configured to store or retrieve (e.g. as a proxy server) vehicle data for presenting to purchaser entities while also accessing account data in records at the resource server that are associated with the purchaser entities.

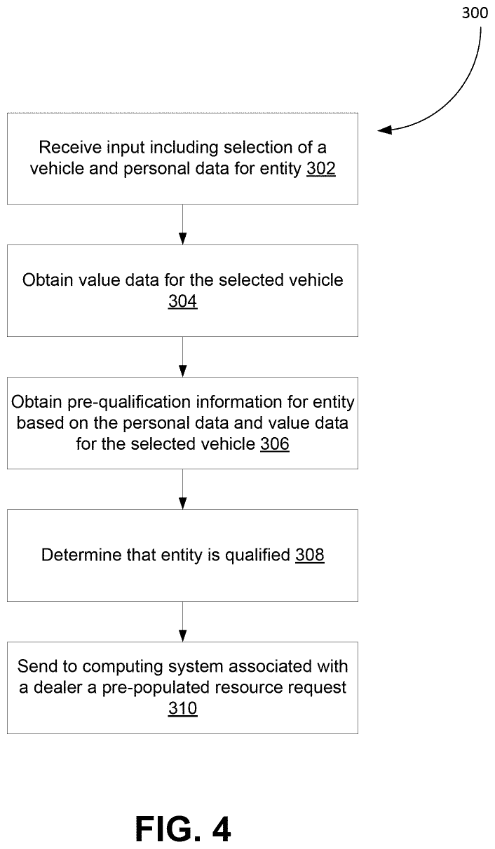

Reference is made to FIG. 4, which shows, in flowchart form, an example method 300 for processing resource requests to a resource server. More specifically, the method 300 allows for handling requests for resources to support purchase activities of a purchaser entity. For example, the operations of method 300 may be performed in processing financing applications to support vehicle purchase activities of a consumer.

Operations 302 and onward are performed by one or more processors of computing devices such as, for example, the processor 200 (FIG. 2) of one or more suitably configured instances of the example computing device 105 (FIG. 2). The method 300 may be performed, for example, by a server system that is communicably connected to a client device associated with a vehicle purchaser entity. The server functions as an intermediary between the client device and computing systems associated with one or more dealers. For example, a server providing backend services for a resource request application on the client device may implement method 300. In at least some embodiments, the method 300 may be performed by the resource server itself. In particular, a resource server (e.g. a financial institution server) may implement method 300 in processing resource requests that are directed to the resource server.

In operation 302, the server receives, from a client device associated with a vehicle purchaser entity, input including a selection of a vehicle and personal data for the purchaser entity. The client device may provide a vehicle selection interface with which a user can interact to indicate choices of vehicles and/or vehicle preference information. For example, the vehicle selection interface may present a plurality of vehicles to the user, and display a progressively filtered list of vehicles based on user input of preferences and selection criteria. A user may, for example, input a vehicle type (e.g. car, truck, SUV, etc.), a make, a model, trim level, etc. A vehicle may be selected responsive to the user input.

The input also includes personal data for the purchaser entity. The personal data may include entity identifying information, such as name, address, and age, driving history (e.g. number of miles driven in specific time periods), and personal insurance information. In some embodiments, the personal data may include financial information, such as income, assets, and outstanding debt obligations.

In operation 304, the server obtains value data for the selected vehicle. In particular, the server may determine a price for the vehicle selected by the purchaser entity. The value data may, for example, be a minimum, a maximum, or an average of values for the selected vehicle among a plurality of dealers. Alternatively, the value data may be a value assigned to the selected vehicle in a data store of vehicle data which may be accessed by the server.

In operation 306, the server obtains pre-qualification information for the purchaser entity based on, at least, the value data for the selected vehicle and user-inputted personal data for the purchaser entity. In some embodiments, the server may determine an estimate of a trade-in value for one or more vehicles. For example, the server may receive, as additional input from the client device, a trade-in value (or an estimate thereof) for vehicles owned by the purchaser entity. Alternatively, the server may retrieve the estimated trade-in values from a database storing vehicle data for a plurality of vehicles by, for example, using an API for access to the database. A user of the client device may be permitted to modify estimates of trade-in values that are retrieved by the server from a database. If trade-in value data is available, the server may determine the pre-qualification information for the entity based, at least in part on, the trade-in value.

The pre-qualification information may indicate, based on the value data for the selected vehicle and personal data for the purchaser entity, whether the selected vehicle is affordable for the purchaser entity. In at least some embodiments, the pre-qualification information may include available resource borrowing information for the purchaser entity and/or an indication of whether the purchaser entity is pre-approved for resource borrowing. The server may, for example, access database records associated with accounts of the purchaser entity at a resource server (e.g. banking profiles or records) to determine whether the purchaser entity has been approved for borrowing resources and, if so, how much can be borrowed by the purchaser entity. In particular, the server may obtain account data associated with the purchaser entity from a database record at the resource server, and the pre-qualification information for the purchaser entity may be determined based on the inputted personal data, the value data for the selected value, and the account data associated with the purchaser entity.

If the selected vehicle is affordable for the purchaser entity based on the pre-qualification information, the purchaser entity is determined to be qualified, in operation 308. Specifically, the purchaser entity is determined to be qualified to obtain financing (e.g. lease or loan) for the selected vehicle.

In response to determining that the purchaser entity is qualified, the server sends, to one or more computing systems associated with dealers for the selected vehicle, a pre-populated resource request, in operation 310. The resource request is pre-populated with at least a portion of the personal data of the purchaser entity. The purchaser entity selects the dealers to which the pre-populated resource request is forwarded. In at least some embodiments, the server may provide to the client device a list of dealers that have the selected vehicle in inventory. The list of dealers may be generated based on inventory availability as well as one or more selection criteria set by the purchaser entity. The selection criteria may comprise various factors relating to the dealers, such as size, location and popularity. For example, the server may identify, based on location information for the purchaser entity, one or more dealers in geographical proximity (e.g. within predefined distance) to the purchaser entity with available inventory of the selected vehicle, and present a list of the identified dealers to the client device. The server retrieves dealer data for the selected dealers and presents it to the client device. The server may also provide other information to the client device, such as payment terms, rates, and options for the identified dealers.

In at least some embodiments, the resource request may be a financing application for obtaining financing for a vehicle purchase. The financing application is directed to a resource server, such as a server associated with a financial institution, lending entity, credit union, etc. In operation 310, the server may automatically initiate a financing application for the purchaser entity and pre-populate the financing application with known information. For example, identifying information (e.g. name, contact information, etc.) associated with the purchaser entity may be pre-populated in the financing application.

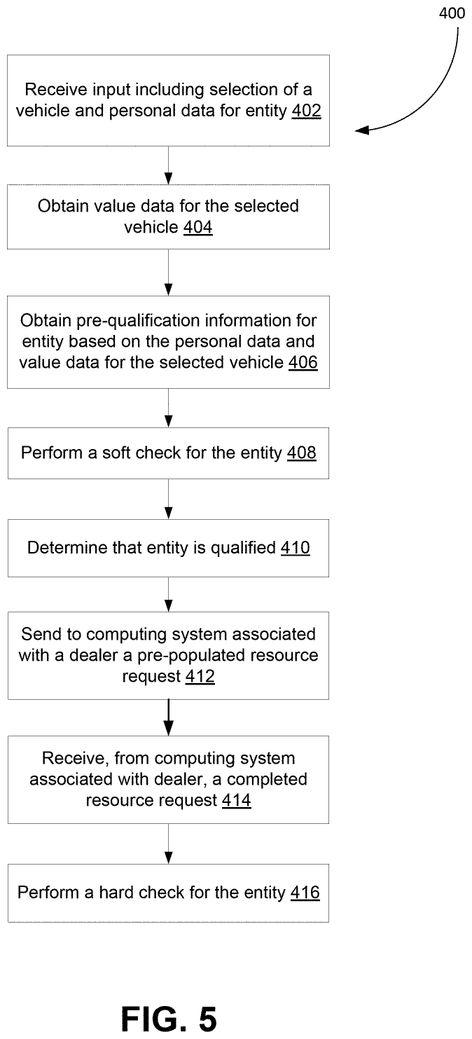

Reference is made to FIG. 5, which shows, in flowchart form, another example method 400 for processing resource requests to a resource server. The method 400 may be performed by a server (e.g. proxy server) that is communicably connected to a client device associated with a vehicle purchaser entity. For example, a server providing backend services for a resource request application on the client device may implement method 400. The server implementing method 400 may, in some embodiments, be the resource server itself. In particular, the resource server (e.g. a financial institution server) may implement method 400 in processing resource requests that are directed to the resource server.

In operation 402, the server receives, from a client device associated with a purchaser entity, input including selection of a vehicle and personal data for the purchaser entity. The server obtains value data, or price, for the selected vehicle in operation 404. Based on, at least, the personal data for the purchaser entity and the value data for the selected vehicle, the server obtains pre-qualification information for the purchaser entity in operation 406. For example, the pre-qualification information may include available resource borrowing information for the purchaser entity and/or indication of pre-approval for the purchaser entity to borrow resources (for example, from a resource server).

In order to pre-qualify a purchaser entity for purchase of a selected vehicle, the server may perform a soft check for the purchaser entity, in operation 408. In particular, a soft check for the purchaser entity may be performed based on historical resource usage data for the purchaser entity. By way of example, the server may perform a soft credit check against the purchaser entity. A soft credit check is a credit check that does not affect the credit score of the subject of the check. To perform a soft check, the server may send a soft inquiry directly to a resource usage tracking server, such as a credit check server (e.g. Equifax server). Alternatively, the server may send a request to a second server, such as a financial services server (e.g. FiServ server), which may route a soft inquiry to a credit check server. The soft inquiry may include, for example, identifying information for the purchaser entity. After sending the soft inquiry, the server may receive, from the resource usage tracking server historical resource usage data for the purchaser entity.

The server may determine, based on the received historical resource usage data, that the purchaser entity is qualified for obtaining financing for the selected vehicle, in operation 410. Specifically, the server may determine that a credit score associated with the purchaser entity is sufficient to qualify the purchaser entity to obtain vehicle financing. For example, the server may compare the received credit score for the purchaser entity to a predefined threshold value (e.g. score of 620). If the purchaser entity's credit score is below the threshold value, the server may determine that the purchaser entity is not qualified to obtain financing for the selected vehicle.

In response to determining that the purchaser entity is qualified, the server sends to one or more computing systems associated with dealers for the selected vehicle, pre-populated resource requests, in operation 412. The dealer(s) are selected by the purchaser entity. In particular, the purchaser entity selects, from one or more dealers identified by the server as having available inventory of the selected vehicle, those dealers to which the pre-populated resource requests will be sent by the server. As discussed above, the server may present, to the client device, a list of dealers based on selection criteria, such as location, size, etc. For example, the server may provide a list of dealers that are within a predefined distance of the purchaser entity and which have available inventory of the selected vehicle. The pre-populated resource requests are further processed by the dealers. A dealer may, for example, add data, such as payment rates, terms, etc., that is specific to the dealer to a pre-populated resource request. Upon completion of the resource request, the dealer computing system may send the resource request to the resource server. In particular, the server receives, from the dealer computing system, a completed resource request, in operation 414.

This role of the server as a centralized system for processing resource requests allows for efficiencies in the vehicle purchase process. Specifically, by initiating and pre-populating a single resource request for a purchaser entity, based on personal data and vehicle selections/preferences received from the purchaser entity, and forwarding the pre-populated resource request to a plurality of different dealers, the disclosed system may reduce overall processing which must be done by the dealer computing systems, thereby saving computing resources (e.g. processing power, memory, etc.) for the dealer systems.

In response to receiving the completed resource request, the server performs a hard check for the purchaser entity based on the historical resource usage data for the entity, in operation 416. Specifically, a hard credit check may be performed upon receipt of the completed resource request. In performing the hard check, the server may itself send a hard inquiry to a resource usage tracking server, or defer the hard check to a second server (e.g. financial services server, such as FiServ server) by requesting the second server to send a hard inquiry to the resource usage tracking server.

In at least some embodiments, the server may perform only the hard check for the purchaser entity. That is, a credit check for a purchaser entity may be performed only after a completed resource request is received from a dealer. In particular, the server may not perform any soft credit checks prior to forwarding a pre-populated resource request for the purchaser entity to a dealer.

Once the hard check is completed, the server provides, to the selected dealers, indications of whether the completed resource requests are approved. In particular, the resource server assesses the completed resource requests, which includes data from the purchaser entity as well as the respective dealers, and either approves or disapproves the completed resource requests. The indications are sent to the respective dealers, which allows the dealers to proceed with finalizing the vehicle sales.

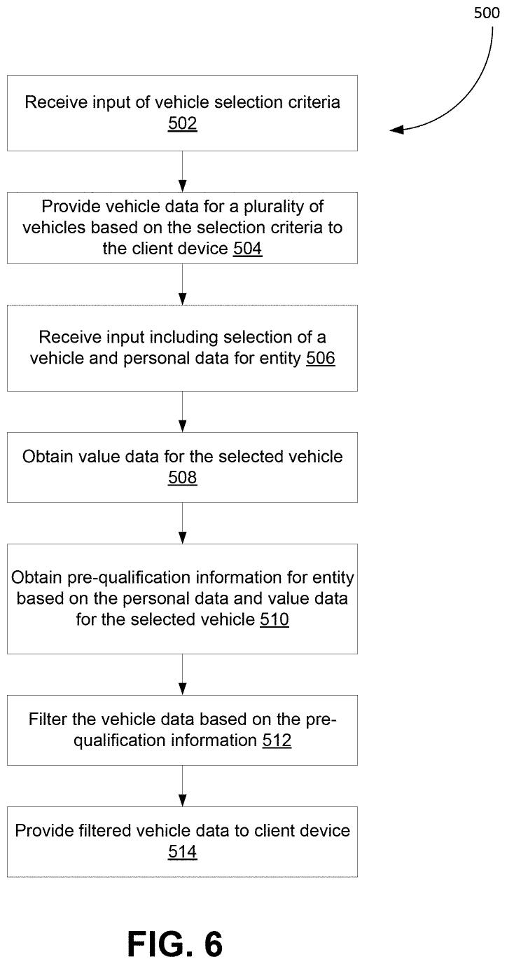

Reference is now made to FIG. 6, which shows an example method 500 for providing vehicle data for a plurality of vehicles to a client device associated with a purchaser entity. The operations of method 500 may be performed as part of methods 300 and 400. In particular, the method 500 may be implemented to facilitate vehicle selection by the purchaser entity, prior to pre-populating of resource requests to provide to one or more dealers for the selected vehicle(s).

Similar to methods 300 and 400 described above, a server (or proxy server) that is communicably connected to the client device may implement method 500. For example, a server providing backend services for a resource request application on a client device associated with a purchaser entity may implement method 500. The server implementing method 500 may, in some embodiments, be the resource server to which resource requests are directed.

In operation 502, the server receives, from a client device associated with a vehicle purchaser entity, vehicle selection criteria. The vehicle selection criteria may, for example, be input by a user of the client device on a user interface associated with a resource request (or vehicle purchase) application resident on the client device. The server then retrieves vehicle data for a plurality of vehicles based on the inputted selection criteria and provides the retrieved vehicle data to the client device, in operation 504. For example, the server may query data stores containing current vehicle data for various vehicles, using the selection criteria specified by the purchaser entity.

The server receives, via the client device, input including selection of a vehicle and personal data for the purchaser entity, in operation 506, and obtains value data for the selected vehicle in operation 508. Based on the personal data for the purchaser entity and the value data for the selected vehicle, the server obtains pre-qualification information for the purchaser entity, in operation 510. The pre-qualification information may indicate that the purchaser entity cannot afford the selected vehicle. That is, the server may determine, based on the pre-qualification information, that the purchaser entity cannot pay for or obtain sufficient financing to purchase the selected vehicle. In response, the server may be configured to filter the vehicle data provided to the client device based on the pre-qualification information, in operation 512. In particular, the server may exclude vehicle data for those vehicles that are determined to be not affordable for the purchaser entity according to the pre-qualification information. The filtered data may then be provided to the client device for presentation on an updated user interface for vehicle selection on the client device, in operation 514.

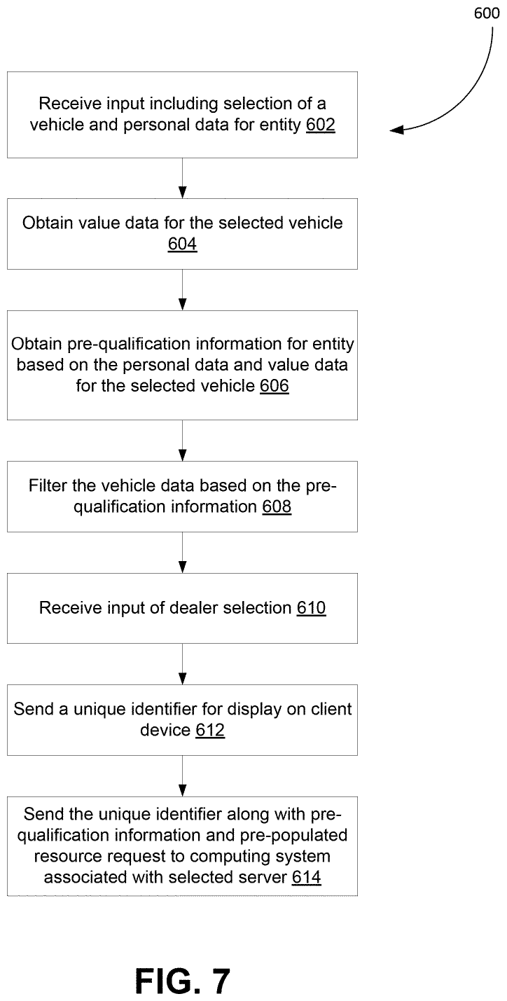

Reference is now made to FIG. 7, which shows, in flowchart form, an example method 600 for matching purchaser entities with vehicle dealers. The operations of method 600 may be performed in conjunction with those of methods 300, 400 and 500. In particular, the method 600 may be implemented as part of a digital process for facilitating vehicle purchases. The method 600 may be implemented by a server that is communicably connected to a client device associated with a purchaser entity and to computing systems associated with one or more vehicle dealers. For example, a resource server, such as a server of a financial institution, to which requests for resource to support vehicle purchase actions may implement method 600.

In operation 602, the server receives, via the client device, selection of a vehicle and personal data for the purchaser entity. The server also obtains, in operation 604, value data (e.g. price) for the selected vehicle. Based on the personal data for the purchaser entity and value data for the selected vehicle, the server obtains pre-qualification information for the purchaser entity, in operation 606. The vehicle data provided to the client device may be filtered to exclude data for vehicles that are not affordable to the purchaser entity. In particular, the server filters vehicle data based on the pre-qualification information for the purchaser entity, in operation 608.

When a selected vehicle is determined to be affordable for the purchaser entity, a dealer for the selected vehicle may be determined, in operation 610. In at least some embodiments, the purchaser entity may be allowed to select a specific dealer. That is, the purchaser entity may input, via the client device, selection of a dealer for the selected vehicle. The purchaser entity may, for example, input desired location information to search for dealers having available inventory of the selected vehicle. The server may retrieve vehicle dealer data based on the dealer selection criteria provided by the purchaser entity.

In some embodiments, the server may generate unique identifying information for facilitating interactions between a purchaser entity and their selected dealer(s). For example, the server may generate a unique identifier, such as a unique number, which is provided to the purchaser entity and the selected dealer. The unique identifier may be transmitted to the client device associated with the purchaser entity for display on said device, in operation 612. The server may also send the unique identifier to the dealer computing system, in operation 614. In addition to the unique identifier, the server may also send, to the dealer computing system, vehicle preference data, the pre-qualification information, and a pre-populated resource request. For example, the server may provide available financing information (e.g. maximum amount of funds that the purchaser entity is qualified to borrow) and/or indications of whether the purchaser entity has been pre-approved for financing, in operation 614.

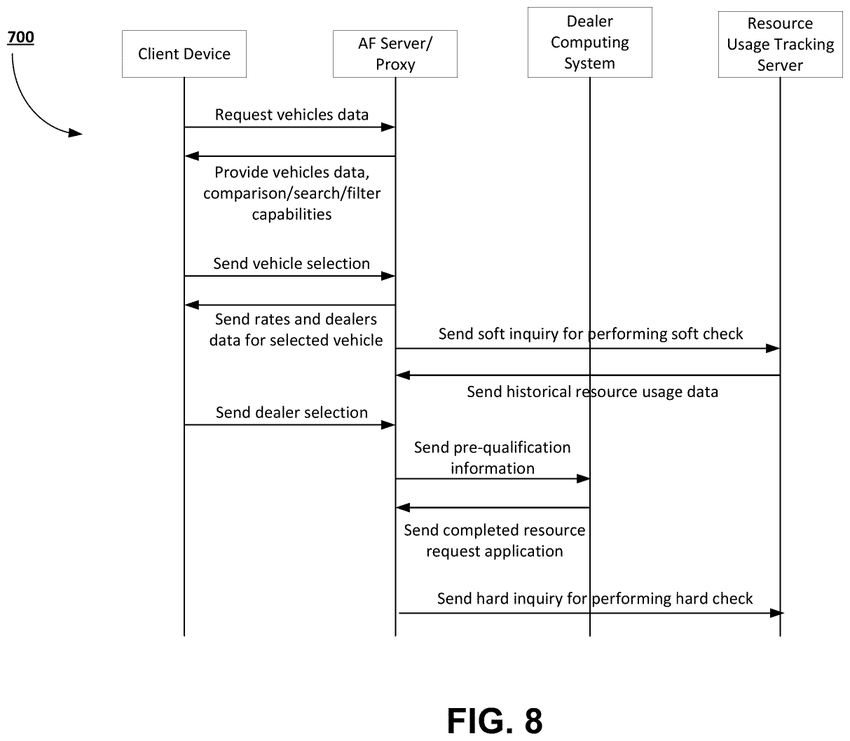

Reference is now made to FIG. 8, which is a sequence diagram illustrating an example process 700 for processing resource requests to a resource server. More specifically, FIG. 8 illustrates a process for generating and handling requests to a resource server for resources to support vehicle purchase action(s) by a purchaser entity. The process 700 may be implemented as part of a digital vehicle retail system comprising client devices associated with purchaser entities, computing systems associated with one or more vehicle dealers, at least one resource usage tracking server (e.g. credit check server), and a resource server such as a server for a financial institution providing vehicle financing.

A purchaser entity, such as a prospective consumer, obtains software (e.g. mobile application, browser extension, etc.) for requesting resources to support vehicle purchase actions on a client device associated with the purchaser entity. For example, a mobile application for facilitating vehicle purchases may be downloaded onto the client device. During initial setup of the mobile application, the client device fetches app configuration settings and captures requisite consent from the purchaser entity.

The client device then requests vehicle data from one or more data stores containing data for a plurality of new and used vehicles. The resource, or vehicle financing, server may serve as a proxy for the client device to connect with the one or more data stores. The server may retrieve, by using suitable APIs for the data stores, the requested vehicle data for presenting to the client device. For example, the client device may receive vehicle data (e.g. vehicle prices, images, descriptions, etc.) and trade-in values for a plurality of vehicles, and provide search, filter, and comparison capabilities based on the received vehicle data.

The client device receives, via input by the purchaser entity, selection of one or more vehicles and sends the selections to the resource server. The resource server, in turn, retrieves rates and dealers' data for the selected vehicles. The rates and dealers' data may be hosted locally at the resource server or obtained from a remote source. The resource server also determines, based on inputs at the client device, pre-qualification information for the purchaser entity. In particular, the resource server may receive, via the client device, input including personal data for the purchaser entity, and obtain additional information for informing whether the purchaser entity is pre-qualified for the selected vehicle. The resource server may, for example, access account data for records maintained by the server and perform soft (credit) checks against the purchaser entity to determine whether the purchaser entity is pre-qualified for financing. In at least some embodiments, the resource server sends a soft inquiry to the resource usage tracking server and receives historical resources usage data indicating creditworthiness of the purchaser entity.

Upon confirming that the purchaser entity is pre-qualified for the selected vehicle, the resource server presents the client device with a list of dealers that have available inventory of the selected vehicle. The client device transmits the purchaser entity's dealer selection to the resource server, and the resource server forwards a resource request (i.e. financing application) to the computing systems associated with the selected dealer. The resource request is pre-populated by the resource server with information regarding the purchaser entity and the selected vehicle. The pre-populated resource request is routed to the selected dealer for further processing. The dealer computing system forwards a completed resource request to the resource server for a full financing adjudication process. For example, the resource server may perform a hard (credit) check against the purchaser entity at this stage.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor;
a memory coupled to the processor, the memory storing processor-executable instructions that, when executed by the processor, configure the processor to:
receive, via a graphical user interface on a client device over a computer network, user input including a selection of a vehicle and personal data for an entity;
obtain, via requests to an application programming interface (API) associated with a database storing vehicle data, value data for the selected vehicle;
access database records associated with accounts of the entity at a resource server to obtain pre-qualification information for the entity, the accessing including obtaining account data associated with the accounts for determining resource borrowing capacity of the entity;
determine, based on the pre-qualification information for the entity, that the entity is qualified for borrowing resources in connection with the selected vehicle; and
in response to determining that the entity is qualified, selectively provide access to the user-inputted personal data for the entity, the selectively providing including:
providing, via the graphical user interface, display data associated with dealer information of dealers for the selected vehicle based on tracked location information;
receiving, via the graphical user interface, selection of dealers;
generating a unique pre-populated resource request for borrowing resources in connection with the selected vehicle; and
transmitting, to a plurality of computing systems associated with the selected dealers over the computer network, the unique pre-populated resource request including the user-inputted personal data.

2. The computing system of claim 1, wherein the pre-qualification information for the entity is obtained based on the user-inputted personal data for the entity, the value data for the selected vehicle, and the account data associated with the accounts.

3. The computing system of claim 1, wherein the pre-qualification information comprises at least one of available resource borrowing information for the entity or an indication of whether the entity is pre-approved for resource borrowing.

4. The computing system of claim 1, wherein the instructions, when executed, further configure the processor to:
obtain a unique identifier for the entity; and
transmit, to the client device, the unique identifier for the entity for displaying via the graphical user interface on the client device.

5. The computing system of claim 1, wherein obtaining pre-qualification information for the entity comprises performing a soft check for the entity based on historical resource usage data for the entity.

6. The computing system of claim 5, wherein performing the soft check for the entity comprises:
sending, to a resource usage tracking server, a soft inquiry including identifying information for the entity; and
receiving, from the resource usage tracking server, the historical resource usage data for the entity.

7. The computing system of claim 6, wherein the instructions, when executed, further configure the processor to:
receive, from a computing system associated with one of the selected dealers over the computer network, a completed resource request, the completed resource request based on the pre-populated resource request; and
in response to receiving the completed resource request, perform a hard check for the entity based on the historical resource usage data for the entity.

8. The computing system of claim 1, wherein the instructions, when executed, further configure the processor to:
receive, from the client device, input of vehicle selection criteria; and
provide, via the graphical user interface on the client device, vehicle data for a plurality of vehicles based on the vehicle selection criteria.

9. The computing system of claim 8, wherein the instructions, when executed, further configure the processor to:
filter the vehicle data based on the pre-qualification information; and
provide, via the graphical user interface on the client device, the filtered vehicle data.

10. The computing system of claim 1, wherein the user input further includes a user-inputted trade-in value, and wherein the pre-qualification information for the entity is determined based on the inputted trade-in value.

11. A processor-implemented method comprising:
receiving, by a computing system via a graphical user interface on a client device over a computer network, user input including a selection of a vehicle and personal data for an entity;
obtaining, by the computing system via requests to an application programming interface (API) associated with a database storing vehicle data, value data for the selected vehicle;
accessing, by the computing system, database records associated with accounts of the entity at a resource server to obtain pre-qualification information for the entity, the accessing including obtaining account data associated with the accounts for determining resource borrowing capacity of the entity;
determining, by the computing system, based on the pre-qualification information for the entity, that the entity is qualified for borrowing resources in connection with the selected vehicle; and
in response to determining that the entity is qualified, selectively provide access to the user-inputted personal data for the entity, the selectively providing including:
providing, by the computing system via the graphical user interface, display data associated with dealer information of dealers for the selected vehicle based on tracked location information;
receiving, by the computing system via the graphical user interface, selection of dealers;
generating, by the computing system, a unique pre-populated resource request for borrowing resources in connection with the selected vehicle; and
transmitting, by a computing system to a plurality of computing systems associated with the selected dealers over the computer network, the unique pre-populated resource request including the user-inputted personal data.

12. The method of claim 11, wherein the pre-qualification information for the entity is obtained based on the user-inputted personal data for the entity, the value data for the selected vehicle, and the account data associated with the accounts.

13. The method of claim 11, wherein the pre-qualification information comprises at least one of available resource borrowing information for the entity or an indication of whether the entity is pre-approved for resource borrowing.

14. The method of claim 11, further comprising:
obtaining a unique identifier for the entity; and
transmitting, by the computing system to the client device, the unique identifier for the entity for displaying via the graphical user interface on the client device.

15. The method of claim 11, wherein obtaining pre-qualification information for the entity comprises performing a soft check for the entity based on historical resource usage data for the entity.

16. The method of claim 15, wherein performing the soft check for the entity comprises:
sending, by the computing system to a resource usage tracking server, a soft inquiry including identifying information for the entity; and
receiving, by the computing system from the resource usage tracking server, the historical resource usage data for the entity.

17. The method of claim 16, further comprising:
receiving, from a computing system associated with one of the selected dealers over the computer network, a completed resource request, the completed resource request based on the pre-populated resource request; and
in response to receiving the completed resource request, performing, by the computing system, a hard check for the entity based on the historical resource usage data for the entity.

18. The method of claim 11, further comprising:
receiving, by the computing system from the client device, input of vehicle selection criteria; and
providing, by the computing system via the graphical user interface on the client device, vehicle data for a plurality of vehicles based on the vehicle selection criteria.

19. The method of claim 18, further comprising:
filtering, by the computing system, the vehicle data based on the pre-qualification information; and
providing, by the computing system via the graphical user interface on the client device, the filtered vehicle data.

20. The method of claim 11, wherein the user input further includes a user-inputted trade-in value, and wherein the pre-qualification information for the entity is determined based on the inputted trade-in value.
